(19) United States
(12) Patent Application Publication
(10) Pub. No.: US 2023/0398426 A1
(43) Pub. Date: Dec. 14, 2023

(54) INTEGRATED PHYSICAL THERAPY AND VIRTUAL REALITY DISPLAY SYSTEM AND METHODS OF USE

(71) Applicants: Mario McKay, Minneapolis, MN (US); Robert Parcia, Tyniec Maly (PL)

(72) Inventors: Mario McKay, Minneapolis, MN (US); Robert Parcia, Tyniec Maly (PL)

(21) Appl. No.: 17/837,148

(22) Filed: Jun. 10, 2022

(51) Int. Cl. A63B 71/06; H04N 13/332; G06F 3/01; G06F 3/0346; G06F 3/14; A63B 21/00; A63B 21/04; A63B 21/055; A63B 69/00

(52) U.S. Cl. CPC A63B 71/0622; H04N 13/332; G06F 3/011; G06F 3/0346; G06F 3/14; A63B 21/154; A63B 21/0442; A63B 21/0552; A63B 69/0064; A63B 2071/0666

(57) ABSTRACT

An integrated physical therapy and virtual reality display system for improved physiotherapeutic exercise experience and outcomes includes a physical therapy device and a virtual reality headset. The physical therapy device allows a user to exercise a selected area of the user's body by supporting or opposing an action of at least one muscle of the user as part of a physiotherapeutic exercise. The virtual reality headset is positionable on a head of the user so that a stereoscopic display of the virtual reality headset is positioned over eyes of the user. The virtual reality headset provides an immersive experience to the user and an improved outcome for the physiotherapeutic exercise.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to physiotherapeutic exercise devices and more particularly pertains to a new physiotherapeutic exercise device for improved physiotherapeutic exercise experience and outcomes. The present invention discloses a novel combination of a physiotherapeutic exercise device with a virtual reality headset.

### (2) Description of Related Art Including Information Disclosed Under 37 CFR 1.97 and 1.98

The prior art relates to physiotherapeutic exercise devices. The prior art relates to physical therapy devices used for physiotherapeutic exercises and to virtual reality headsets. The prior art comprises numerous physical therapy device that are used for physiotherapeutic exercises and a variety of virtual reality headsets. Virtual reality headsets are generally used for entertainment purposes, but also have found utility in training medical students, in the performance of surgical procedures, and in training military personal without the use of live weapons. The prior art does not teach a system comprised of a physical therapy device and a virtual reality headset for performing physiotherapeutic exercises.

### BRIEF SUMMARY OF THE INVENTION

An embodiment of the disclosure meets the needs presented above by generally comprising a physical therapy device and a virtual reality headset. The physical therapy device allows a user to exercise a selected area of the user's body by supporting or opposing an action of at least one muscle of the user as part of a physiotherapeutic exercise. The virtual reality headset is configured to be positioned on a head of the user so that a stereoscopic display of the virtual reality headset is positioned over eyes of the user. The virtual reality headset provides an immersive experience to the user and an improved outcome for the physiotherapeutic exercise.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an integrated physical therapy and virtual reality display system according to an embodiment of the disclosure.

FIG. 2 is a front view of an embodiment of the disclosure.

FIG. 3 is a side view of an embodiment of the disclosure.

FIG. 4 is a detail view of an embodiment of the disclosure.

FIG. 5 is an in-use view of an embodiment of the disclosure.

FIG. 6 is an in-use view of an embodiment of the disclosure.

FIG. 7 is a flow diagram for a method utilizing an embodiment of the disclosure.

### DETAILED DESCRIPTION OF THE INVENTION

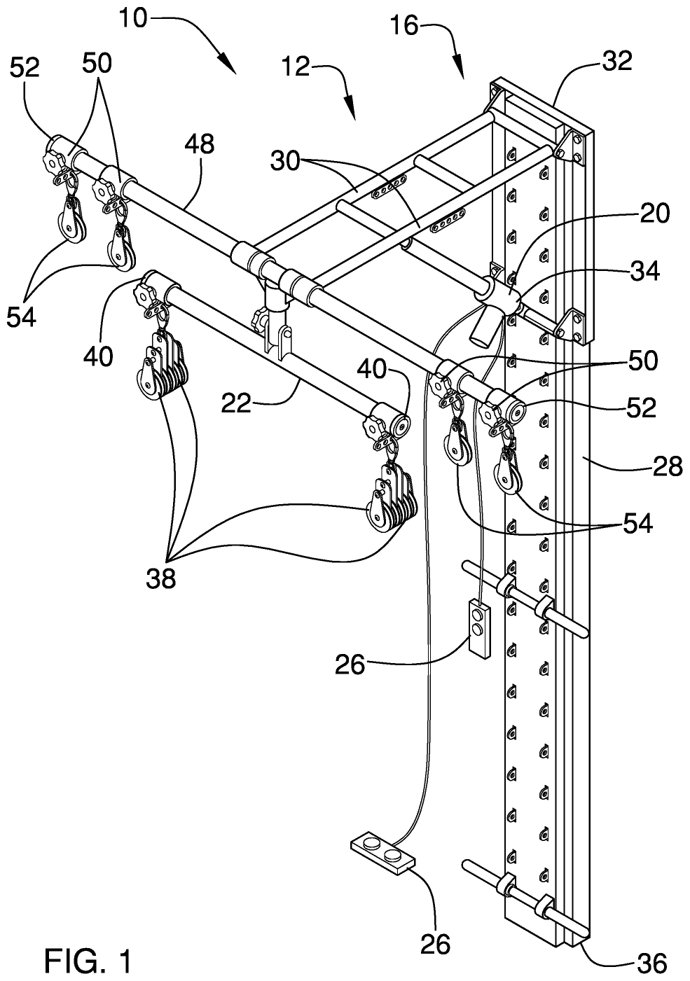

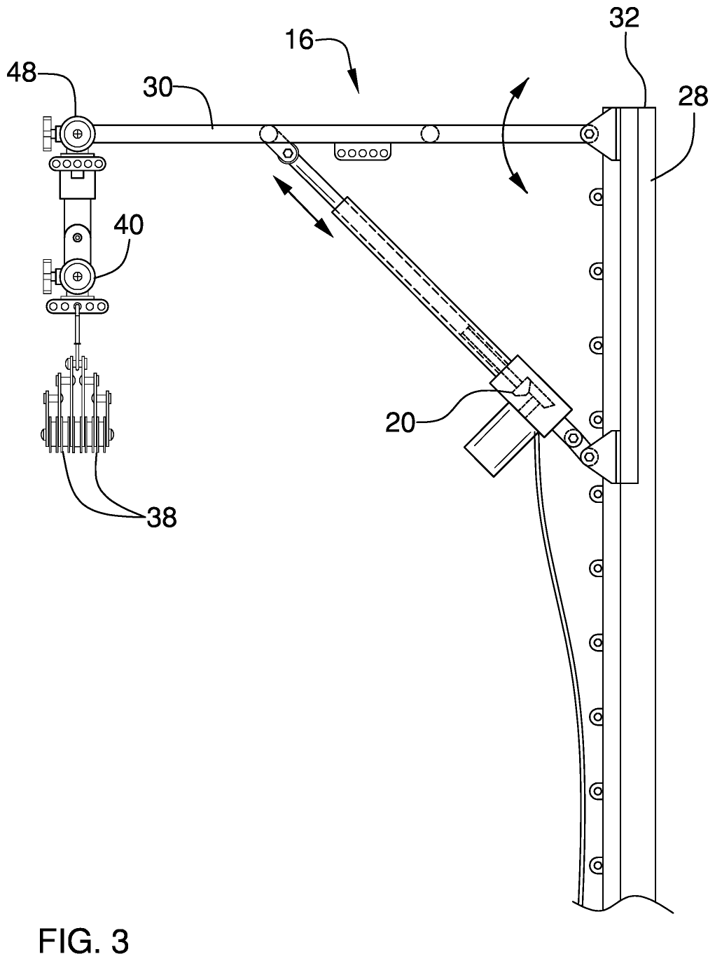

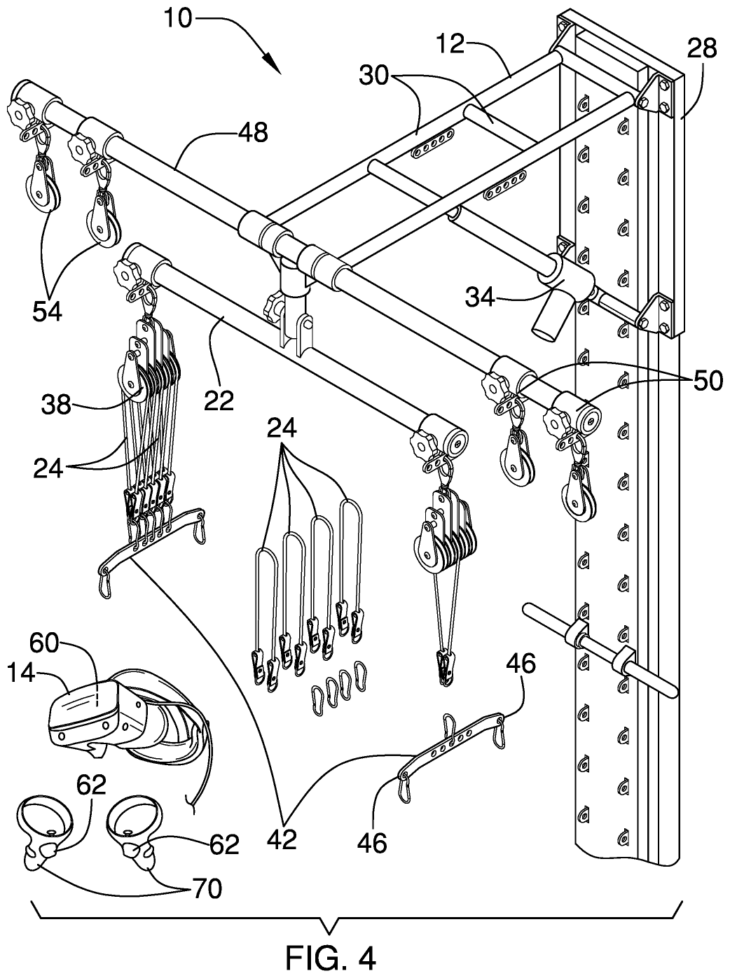

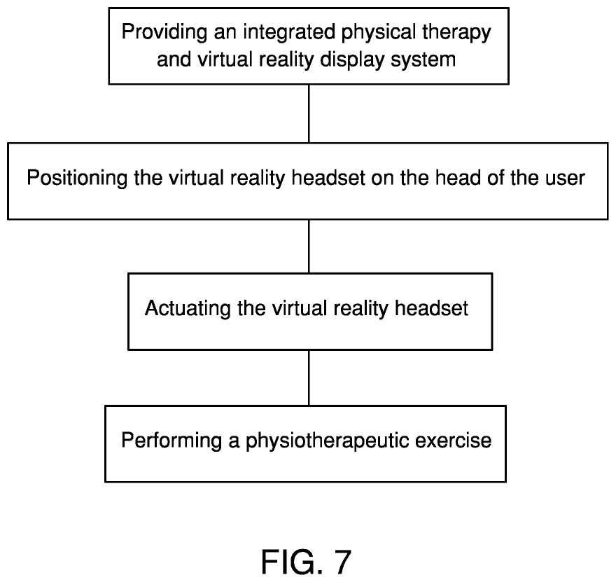

With reference now to the drawings, and in particular to FIGS. 1 through 7 thereof, a new physiotherapeutic exercise device embodying the principles and concepts of an embodiment of the disclosure and generally designated by the reference numeral 10 will be described.

As best illustrated in FIGS. 1 through 7, the integrated physical therapy and virtual reality display system 10 generally comprises a physical therapy device 12 and a virtual reality headset 14. The physical therapy device 12 is configured to be utilized by a user to exercise a selected area of the user's body by supporting or opposing an action of at least one muscle of the user. The physical therapy device 12 may comprise a physical therapy exercise station 16, or other types of physical therapy devices, which are well known to those skilled in the art of physical therapy devices.

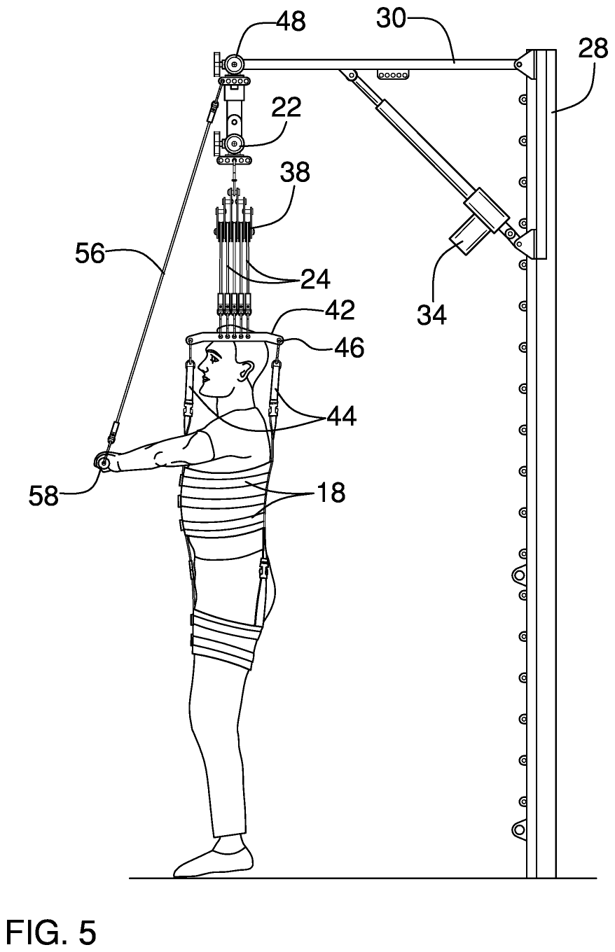

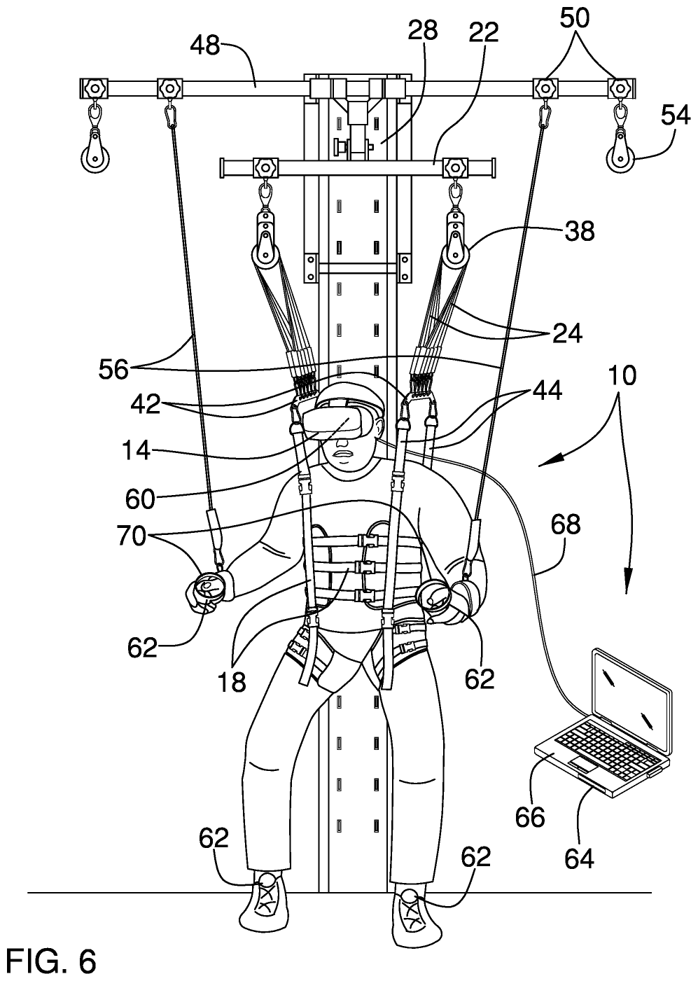

By way of example, a physical therapy exercise station 16 comprising a harness 18 and a hoist 20 is described below and is shown in FIGS. 1-6. It will be obvious to those skilled in the art of physical therapy exercise stations that many additional configurations are possible, and these additional configurations are anticipated by the present invention. The harness 18 is configured to be positioned on a user, as is shown in FIGS. 5 and 6. The hoist 20 is mountable to an element of a structure, such as a wall, ceiling, frame, or the like. A first bar 22 is attached to the hoist 20. A plurality of tethers 24 is attached to the first bar 22. Each tether 24, which comprises rubber tubing, elastomers, or the like, and thus is resiliently stretchable, is selectively attachable to the harness 18.

A controller 26 is operationally engaged to the hoist 20 so that the controller 26 is positioned to selectively actuate the hoist 20. The hoist 20 is configured to selectively lift and to lower the user who is positioned in the harness 18. As shown in FIG. 1, two controllers 26, one hand operated and the other foot operated, are operationally engaged to the hoist 20.

The physical therapy exercise station 16 comprises a plate 28, which is configured to be mountable to a substantially vertical element of the structure, such as a wall, post, or the like. A frame 30 is hingedly attached to the plate 28 proximate to an upper end 32 of the plate 28. In this configuration, the first bar 22 is attached to and extends bidirectionally from the frame 30 distal from the plate 28. The hoist 20 comprises a linear actuator 34, which is hingedly attached to and which extends between the plate 28 and the frame 30. A variety of linear actuators are known in the prior art and are anticipated by the present invention.

The frame 30 and the linear actuator 34 may be selectively attachable to the plate 28 so that the frame 30 and the linear actuator 34 are selectively positionable between the upper end 32 and a lower end 36 of the plate 28, thus allowing the physical therapy exercise station 16 to be fitted to users having a variety of heights.

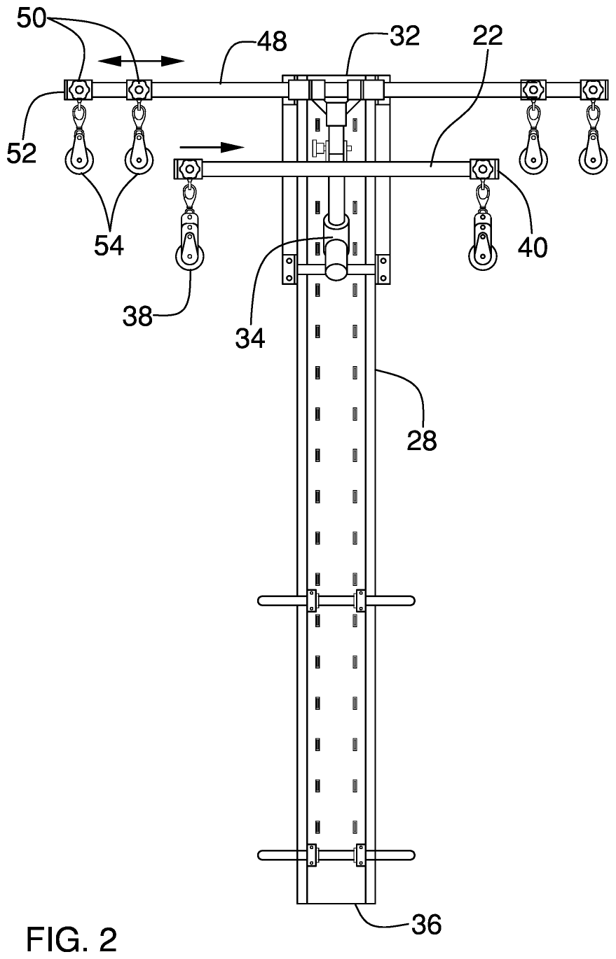

A plurality of pulleys 38 is attached to the first bar 22, with each tether 24 being positioned around a respective pulley 38. In one embodiment, the plurality of pulleys 38 comprises two sets of pulleys 38, as is shown in FIG. 2, with each set of pulleys 38 being positioned proximate to a respective opposed terminus 40 of the first bar 22. The sets of pulleys 38 are configured to bracket shoulders the user, as is shown in FIG. 6. Each of a pair of mounts 42 is attached to tethers 24 so that it extends from a respective set of pulleys 38. A plurality of straps 44 is attached to and extends between the harness 18 and the pair of mounts 42 so that each opposing endpoint 46 of each mount 42 is attached to a respective strap 44. The physical therapy exercise station 16 enables substantially unlimited movement for the user without fear of falling or injury. The physical therapy exercise station 16 reduces the labor associated with securing the user during therapy and does not require a large amount of strength by a therapist performing the therapy.

The integrated physical therapy and virtual reality display system 10 also may include a second bar 48, which is attached to and which extends bidirectionally from the frame 30 distal from the plate 28. The second bar 48 is dimensionally longer than the first bar 22. A plurality of connectors 50 is attached to the second bar 48 so that respective connectors 50 are selectively positionable proximate to opposed ends 52 of the second bar 48. Each of a plurality of sheaves 54 is selectively attachable to a respective connector 50. Each of a plurality of resilient cords 56 is selectively attachable to a respective connector 50 or to a respective sheave 54. Each of a plurality of handles 58 is selectively attachable to at least on resilient cord 56 distal from the second bar 48. The handle 58 thus is configured to be grasped in at least one hand of the user for preforming a physiotherapeutic exercise. Variations in engagement of the resilient cords 56 to the connectors 50 and sheaves 54, or to points elsewhere upon the physical therapy exercise station 16, and use of handles 58 for one or two hands, allows for a variety of physiotherapeutic exercises to be performed.

The above includes one embodiment of a physical therapy exercise station 16 wherein a user's movements are facilitated by their suspension in the harness 18 so that they may, for example, make simulated walking movements or placed such that their feet touch the floor or a treadmill but their mass is at least partially supported by the physical therapy exercise station 16. Though not shown, motors may be incorporated to either assist or to resist movement of the person's arms and/or legs. Moreover, the physical therapy exercise station 16 may not be stationary but may be positioned on a movable rig allowing the user to move within a defined area.

The virtual reality headset 14 is configured to be positioned on a head of the user with a stereoscopic display 60 of the virtual reality headset 14 being positioned over eyes of the user. The virtual reality headset 14 is configured to provide an immersive experience to the user and an improved outcome for the physiotherapeutic exercise. Additionally, the present invention anticipates the virtual reality headset 14 being replaced by an augmented reality display (not shown).

The integrated physical therapy and virtual reality display system 10 also may include a plurality of sensors 62, which is operationally engaged to the virtual reality headset 14. Each sensor 62 is configured to be attached to a respective limb of the user and is configured to relay three dimensional positioning of the respective limb to the virtual reality headset. The present invention also anticipates the integrated physical therapy and virtual reality display system 10 comprising a motion sensing input device (not shown, but well known to those skilled in the art of virtual reality hardware devices), which is operationally engaged to the virtual reality headset 14. The motion sensing input device would perform real-time gesture recognition and body skeletal detection and thus could be used in place of the plurality of sensors 62.

As is shown in FIGS. 5 and 6, sensors 62 are attached singly to each hand and foot of the user. With users having neurological problems, the users can be verticalized and fitted with the virtual reality headset 14. With the user's movements being facilitated by their suspension in the harness 18, they can experience walking in a virtual world upon movement of their feet. The highly visual sensory stimulation and vertical positioning, in combination with feeling safe on the physical therapy exercise station 16, promotes relaxation of the user and leads to improved outcomes for physiotherapeutic exercises.

The integrated physical therapy and virtual reality display system 10 also may include a pair of hand controllers 70, each of which is configured to be positioned on a respective hand of the user. The hand controllers 70 are configured to allow input of commands into the virtual reality headset 14. Respective sensors 62 may be integral to the hand controllers 70.

The integrated physical therapy and virtual reality display system 10 also may include a computer 64, upon which a plurality of virtual reality videos 66 is positioned. A cable 68 is operationally engaged to and extends between the computer 64 and the virtual reality headset 14. The computer 64 can selectively transmit a respective virtual reality video 66 to the virtual reality headset 14.

The integrated physical therapy and virtual reality display system 10 enables a method of performing a physiotherapeutic exercise. The method comprises a first step of providing an integrated physical therapy and virtual reality display system 10 according to the disclosure above. A second step of the method is positioning the virtual reality headset 14 on a head of the user. A third step of the method is actuating the virtual reality headset 14. A fourth step of the method is performing a physiotherapeutic exercise with the physical therapy device 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An integrated physical therapy and virtual reality display system comprising:
a physical therapy device configured for being utilized by a user to exercise a selected area of the user's body by supporting or opposing an action of at least one muscle of the user as part of a physiotherapeutic exercise; and
a virtual reality headset configured for positioning on a head of the user, such that a stereoscopic display of the virtual reality headset is positioned over eyes of the user, wherein the virtual reality headset is configured for providing an immersive experience to the user and an improved outcome for the physiotherapeutic exercise.

2. The integrated physical therapy and virtual reality display system of claim 1, wherein the physical therapy device comprises a physical therapy exercise station including a harness for supporting the user.

3. The integrated physical therapy and virtual reality display system of claim 2, wherein the physical therapy exercise station comprises:
the harness configured for positioning on a user;
a hoist configured to be mountable to an element of a structure;
a first bar attached to the hoist;
a plurality of tethers attached to the first bar, each tether being selectively attachable to the harness; and
a controller operationally engaged to the hoist, such that the controller is positioned for selectively actuating the hoist, wherein the hoist is configured for selectively lifting and lowering the user positioned in the harness.

4. The integrated physical therapy and virtual reality display system of claim 3, further including the physical therapy exercise station comprising:
a plate configured to be mountable to a substantially vertical element of the structure;
a frame hingedly attached to the plate proximate to an upper end of the plate, the first bar being attached to and extending bidirectionally from the frame distal from the plate; and
the hoist comprising a linear actuator hingedly attached to and extending between the plate and the frame.

5. The integrated physical therapy and virtual reality display system of claim 4, wherein the frame and the linear actuator are selectively attachable to the plate, such that the frame and the linear actuator are selectively positionable between the upper end and a lower end of the plate.

6. The integrated physical therapy and virtual reality display system of claim 3, further including the tethers being resiliently stretchable.

7. The integrated physical therapy and virtual reality display system of claim 6, further including the tethers comprising rubber tubing.

8. The integrated physical therapy and virtual reality display system of claim 3, further including a plurality of pulleys attached to the first bar, each tether being positioned around a respective pulley.

9. The integrated physical therapy and virtual reality display system of claim 8, further including:
the plurality of pulleys comprising two sets of pulleys, each set of pulleys being positioned proximate to a respective opposed terminus of the first bar, wherein the sets of pulleys are configured for bracketing shoulders the user;
a pair of mounts, each mount being attached to tethers extending from a respective set of pulley; and
a plurality of straps attached to and extending between the harness and the pair of mounts, such that each opposing endpoint of each mount is attached to a respective strap.

10. The integrated physical therapy and virtual reality display system of claim 3, further including:
a second bar attached to and extending bidirectionally from the frame distal from the plate, the second bar being dimensionally longer than the first bar;
a plurality of connectors attached to the second bar, such that respective connectors are selectively positionable proximate to opposed ends of the second bar;
a plurality of sheaves, each sheave being selectively attachable to a respective connector;
a plurality of resilient cords, each resilient cord being selectively attachable to a respective connector or a respective sheave; and
a plurality of handles, each handle being selectively attachable to at least on resilient cord distal from the second bar, wherein the handle is configured for grasping in at least one hand of the user for preforming a physiotherapeutic exercise.

11. The integrated physical therapy and virtual reality display system of claim 1, further including a plurality of sensors operationally engaged to the virtual reality headset, each sensor being configured for attaching to a respective limb of the user, wherein the sensor is configured for relaying three dimensional positioning of the respective limb to the virtual reality headset.

12. The integrated physical therapy and virtual reality display system of claim 11, further including a pair of hand controllers, each hand controller being configured for positioning on a respective hand of the user, wherein the hand controller is configured for inputting of commands into the virtual reality headset.

13. The integrated physical therapy and virtual reality display system of claim 12, further including a respective sensor being integral to the hand controller.

14. The integrated physical therapy and virtual reality display system of claim 1, further including:
a computer;
a cable operationally engaged to and extending between the computer and the virtual reality headset; and
a plurality of virtual reality videos positioned on the computer, such that the computer can selectively transmit a respective virtual reality video to the virtual reality headset.

15. A method of performing a physiotherapeutic exercise utilizing an integrated physical therapy and virtual reality display system, the method comprising the steps of:
providing an integrated physical therapy and virtual reality display system comprising:
a physical therapy device configured for being utilized by a user to exercise a selected area of the user's body by supporting or opposing an action of at least one muscle of the user as part of a physiotherapeutic exercise, and
a virtual reality headset configured for positioning on a head of the user, such that a stereoscopic display of the virtual reality headset is positioned over eyes of the user, wherein the virtual reality headset is configured for providing an immersive experience to the user and an improved outcome for the physiotherapeutic exercise;
positioning the virtual reality headset on a head of the user;
actuating the virtual reality headset; and
performing a physiotherapeutic exercise with the physical therapy device.

16. The method of claim 15, wherein the physical therapy device comprises a physical therapy exercise station.

17. The method of claim 15, wherein, further including:
a plurality of sensors operationally engaged to the virtual reality headset, each sensor being configured for attachment to a respective limb of the user, wherein the sensor is configured for relaying three dimensional positioning of the respective limb to the virtual reality headset; and
a pair of hand controllers, each hand controller being configured for positioning on a respective hand of the user, wherein the hand controller is configured for inputting of commands into the virtual reality headset.
